(19) United States
(12) Patent Application Publication
(10) Pub. No.: US 2009/0306878 A1
(43) Pub. Date: Dec. 10, 2009

(54) Method and device for controlling the fuel metering into at least one combustion chamber of an internal combustion engine

(76) Inventors: Khaled Ben Yahia, Stuttgart (DE); Michael Schueller, Friolzheim (DE); Lars Reichelt, Stuttgart (DE)

Correspondence Address: KENYON & KENYON LLP, ONE BROADWAY, NEW YORK, NY, 10004, US

(21) Appl. No.: 12/227,455

(22) PCT Filed: May 4, 2007
(86) PCT No.: PCT/EP2007/054338

§ 371 Date: Jul. 21, 2009

(30) Foreign Application Priority Data
Jun. 9, 2006 (DE) 10 2006 026 876.8

(51) Int. Cl. F02D 41/30

(52) U.S. Cl. 701/104

(57) ABSTRACT

In a device and a method for controlling the fuel metering into at least one combustion chamber of an internal combustion engine, on the basis of at least one operating characteristic quantity, a control quantity is prespecified that determines the injected quantity of fuel. On the basis of a cylinder pressure quantity that characterizes the cylinder pressure and the at least one operating characteristic quantity, a correction value is prespecified for correcting the control quantity.

### BACKGROUND OF THE INVENTION

1. Field of the Invention

The present invention relates to a method and a device for controlling the fuel metering into at least one combustion chamber of an internal combustion engine.

2. Description of Related Art

Standardly, for this purpose, on the basis of at least one operating characteristic quantity, such as for example the quantity of fuel to be injected, a control signal for an actuating element is prespecified that determines the quantity of fuel that is to be injected into the at least one combustion chamber. Such a method for such a device is known for example, from published German patent document DE 197 12 143.

As a control signal, standardly a control duration or control angle are prespecified. Alternatively to these quantities, arbitrary other quantities may be prespecified that determine the quantity of fuel to be injected. Any signal that characterizes the fuel quantity to be injected may be used as a control signal.

Standardly, the control duration of the actuating element is stored only as a function of the desired fuel quantity and the fuel pressure, in a control duration characteristic map. The determination of a control duration characteristic map for injectors of a common-rail system is standardly carried out on the engine test bench, with one injection per work cycle. The beginning of the injection is varied slightly, as a function of the load, in the area of the top dead center of the respective cylinder. In these injections, due to the pressure in the combustion chamber deviations in quantity do not occur, because the corresponding control duration characteristic map was already determined at the same combustion chamber pressure. For injections that are carried out far before top dead center or after top dead center, or after the combustion, the combustion chamber pressure deviates significantly from the combustion chamber pressure at which the control duration characteristic map was determined. For these injections, this results in a quantity error. In particular, these errors occur in the case of a pre-injection and/or a post-injection.

This means significant quantity errors occur as a function of the time or angular position of the crankshaft at which this pre-injection and/or post-injection takes place. Various functionalities engage with this pre-injection or post-injection. For these functionalities, the quantity error is a problem, because these merely control, and do not engage in a regulating manner. Such functions include for example a pressure wave compensation or a null quantity calibration.

### BRIEF SUMMARY OF THE INVENTION

According to the present invention, it was recognized that these quantity errors are based on the fact that the injection quantity is a function of the combustion chamber pressure prevailing during the injection. The combustion chamber pressure during the pre-injection and/or post-injection deviates significantly from the combustion chamber pressure that prevails during the main injection.

In particular in hydraulically controlled injection systems, such as for example common-rail injectors having an electrical controlling and a control chamber, the needle opening characteristic is a function of the equilibrium of forces at the jet needle. This equilibrium of forces is determined essentially by the pressure in the control chamber and the pressure in the combustion chamber. This equilibrium of forces is additionally influenced via the cylinder pressure present at the jet needle when the injector is closed. This influencing is typically such that a high cylinder counter-pressure supports the opening characteristic of the jet; i.e., given the same electrical controlling, the injection begins at an earlier point in time. On the other hand, the injection rate is in turn a function of the counter-pressure; i.e., given a high counter-pressure, the maximum rate decreases because the pressure difference between the rail pressure and the counter-pressure becomes smaller.

The fact that the cylinder pressure is taken into account means that the metering precision can be increased. This has the further advantage that the quantity correction functions that use the injection quantity as an input quantity operate at the correct operating point.

The fact that a correction value for correcting the control quantity is determined on the basis of a cylinder pressure quantity that characterizes the cylinder pressure results in a significantly improved fuel metering. In this way, the effects are compensated that result from the fact that the injector or the pump-jet unit displays different opening behavior when the combustion chamber pressure is different. This changed opening behavior results in a different injected quantity, and, possibly, to a changed beginning of the injection. This is due to the fact that the pressure influences the opening of the injector. Depending on the design of the injector, an increased combustion chamber pressure can result in an easier opening, i.e. an increased fuel quantity, or a more difficult opening and thus a smaller quantity of fuel. In addition, the effect also occurs that given an increased combustion chamber pressure the injection rate decreases due to the smaller pressure difference between the fuel pressure and the combustion chamber pressure.

It is particularly advantageous that the correction value is determined as a function of the cylinder pressure quantity, and in addition as a function of the operating point of the internal combustion engine or the operating point of the injector.

This is realized in that the output signal of the control characteristic map is corrected as a function of the input quantities of the control characteristic map and the cylinder pressure.

It is particularly advantageous if as an operating characteristic quantity a quantity (P) is used that characterizes the fuel pressure. This quantity is available in particular in common-rail systems. In addition, the fuel pressure or the rail pressure has a significant influence on the behavior of the actuating element.

Another quantity that significantly influences the behavior of the actuating element is the fuel quantity to be injected.

This is also present in control devices for controlling an internal combustion engine. Various signals present in the control device may be used as a quantity (QK) that characterizes the fuel quantity to be injected.

In order to acquire the cylinder pressure quantity (PZ), a sensor is preferably used. This sensor can also be used to determine additional quantities that are then used in the controlling of the internal combustion engine. In an economical alternative solution, it can also be provided that this quantity is determined on the basis of other operating characteristic quantities; i.e., is calculated or is read out from a characteristic map.

### BRIEF DESCRIPTION OF THE SEVERAL VIEWS OF THE DRAWING

FIG. 1 shows the essential elements of the method and the device for controlling the internal combustion engine.

FIG. 2 presents in detail the determination of the correction values for the control quantity.

### DETAILED DESCRIPTION OF THE INVENTION

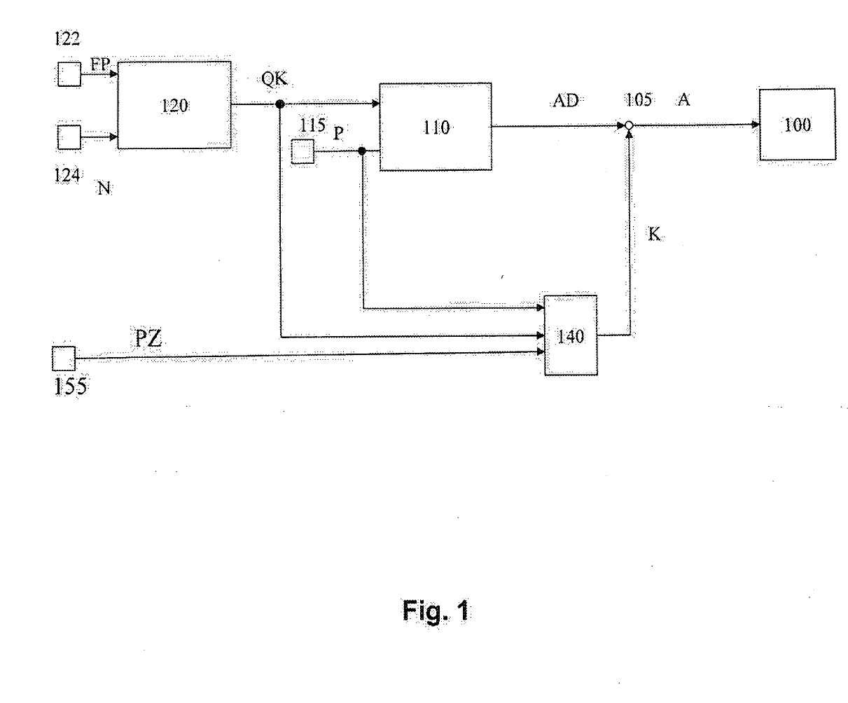

FIG. 1 shows a schematic block diagram of the procedure according to the present invention. An actuating element is designated 100. This element is charged with a control signal A. Control signal A is formed at combination point 105 by combining output signal AD of a control duration characteristic map 110 and a correction value K. Output signal P of first sensors 115 and output signal QK of a quantity pre-specification unit 120 are supplied to control duration characteristic map 110. Output signal FP of second sensors 122 and a signal N of third sensors 124 are supplied to quantity pre-specification unit 120.

The actuating element is preferably formed as an injector of a common-rail system or as a pump-jet element. The duration of the control signal with which a magnetic valve or a piezoactuator is charged determines the injected quantity of fuel.

The correction value is provided by a correction unit 140 that is charged with input signals QK and P of control characteristic map 110 and with output signal PZ of a fourth sensor 155.

In control duration characteristic map 110, the control signal for actuating element 100 is stored as a function of the operating point defined by at least the quantity QK. The operating point is determined by at least one operating characteristic quantity. In the depicted exemplary embodiment, the operating point is determined by a quantity QK that characterizes the quantity of fuel that is to be injected and by a quantity P that characterizes the fuel pressure. Quantity QK is pre-specified by the quantity pre-specification unit, preferably as a function of a signal FP, which characterizes the driver's wishes, and of a rotational speed quantity N. Quantity P is measured by sensor 115. This is a quantity that characterizes the fuel pressure. In a common-rail system, this quantity is standardly designated the rail pressure.

In order to compensate the influence of cylinder pressure PZ, correction unit 140 prespecifies correction value K as a function of at least the cylinder pressure PZ and another operating characteristic quantity QK and/or P. It is particularly advantageous if the correction value is prespecified as a function of cylinder pressure PZ and the input quantities of control characteristic map 110. Using correction value K, in combination point 105 output signal AD of control duration characteristic map 110 is then corrected. Cylinder pressure PZ is measured using a sensor 155 or is determined on the basis of other quantities.

The control duration characteristic map is provided with data at a defined reference pressure PR. Correction value K is determined using a model-based approach that is optimized for computing run time and resources. For this purpose, preferably a quadratic approximation formula is used. Here, the required control duration correction value K for achieving the desired quantity at combustion chamber pressure PZ, which differs from reference pressure PR, is calculated according to the following formula:

K=(PZ·PR)*X+(PZ−PR)*(PZ−PR)*Y

Here, X and Y are parameters that, with the aid of an application tool, are determined off-line from the raw data, for each operating point of the injector, and are stored in the control device in characteristic maps.

Alternatively, other formulas or models may be used. In addition, it can be provided that the correction values are stored in corresponding characteristic maps.

Characteristic map 110 is measured for various cylinder pressures. On the basis of these measurement values, factors x and y are then determined. Parameters x and y are determined from the raw data at each operating point of the injector during the application phase and are stored in the control device in characteristic maps.

This procedure is particularly advantageous because the correction has a sufficient degree of precision and requires only a small amount of storage space and computing run time. Alternatively to the above formula, other formulas may also be used to calculate the correction value, on the basis of the pressure difference between the actual value and the reference value.

In another alternative, it can be provided that an inverted injector model is used.

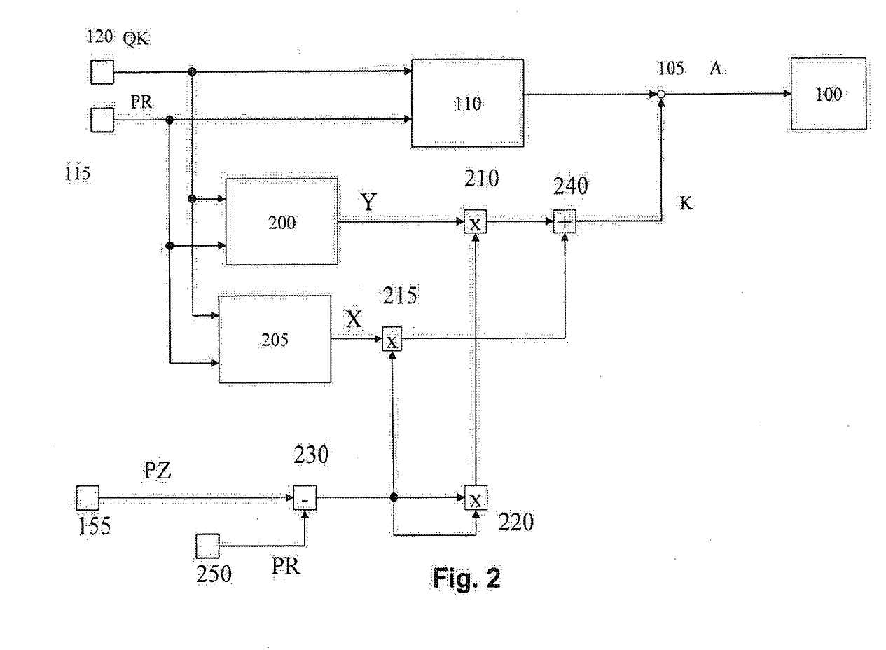

A realization of this procedure is shown in detail in FIG. 2. Elements already described in FIG. 1 are designated with the same reference characters. Quantities QK and P are also provided to a first characteristic map 200 and to a second characteristic map 210. Factor Y is stored in first characteristic map 200, and in second characteristic map 205 factor x is stored as a function of the operating point of the injector. It is preferably provided that as input quantities for characteristic maps 200 and 210, the same input quantities are used as were used for control duration characteristic map 110. In combination point 210 or combination point 215, output signals X or Y of the characteristic maps are compared to the output signal of combination point 220, or are combined, preferably multiplicatively, to the output signal of subtraction point 230. The two output signals of combination points 210 and 215 are supplied to combination point 240, which combines these two signals, preferably additively. Correction value K is adjacent to the output of combination point 240.

On the one hand, output signal PZ of sensor 155 for the combustion chamber pressure and the output signal of a reference value pre-specification unit 250 are supplied to subtraction point 230. Reference pressure PR is adjacent to the output of reference value pre-specification unit 250. Reference pressure PR is the combustion chamber pressure at which control duration characteristic map 110 was measured.

Elements 200 to 250 shown in FIG. 2 reproduce the above-indicated formula.

According to the present invention, a linear correction is provided as a function of the difference between reference value PR and current combustion chamber pressure PZ, and a quadratic correction is also provided. For the linear correction, a factor X is stored in characteristic map 205, and for the quadratic correction a factor Y is stored in characteristic map 200, as a function of the operating point of the injector. For these factors, on the one hand the difference and on the other hand the square of the difference are multiplied, and in this way correction value K is calculated using a quadratic approach.

This procedure is used for all injection types, i.e. the pre-injections, the main injection, and the post-injections. A possible deactivation, as a function of the operating point of the injector, is provided in another particularly advantageous embodiment. This deactivation permits a savings in computing run time when it is expected that there will be only a slight need for correction. This is true for example given large injected quantities or high fuel pressures. Thus, it can be provided that correction value K reaches combination point 105 via a corresponding switching device that is controlled as a function of the operating state of the internal combustion engine.

A particularly advantageous further embodiment provides that a corresponding correction is provided in order to correct the beginning of the controlling; i.e., in addition to the duration of the controlling, the beginning of the controlling is also corrected.

1-8. (canceled)

9. A method for controlling a fuel metering into at least one combustion chamber of an internal combustion engine, comprising:
specifying, on the basis of at least one operating characteristic quantity, a control quantity that determines injected quantity of fuel; and
specifying, on the basis of the at least one operating characteristic quantity and a cylinder pressure quantity that characterizes a cylinder pressure, a correction value for correcting the control quantity.

10. The method as specified in claim 9, wherein the operating characteristic quantity is a quantity that characterizes a fuel pressure.

11. The method as specified in claim 9, wherein the operating characteristic quantity is a quantity that characterizes a quantity of fuel to be injected.

12. The method as recited in claim 9, wherein the cylinder pressure quantity is measured using a sensor.

13. The method as recited in claim 9, wherein the correction value is determined on the basis of a difference between a specified reference value and a current value for the cylinder pressure quantity.

14. The method as recited in claim 13, wherein the correction value is determined on the basis of the difference and at least one factor that is a function of the at least one operating characteristic quantity.

15. The method as recited in claim 9, wherein the cylinder pressure quantity is determined on the basis of the at least one operating characteristic quantity.

16. A device for controlling a fuel metering into at least one combustion chamber of an internal combustion engine, comprising:
an arrangement configured to specify, on the basis of at least one operating characteristic quantity, a control quantity that determines injected quantity of fuel; and
a correction unit configured to specify, on the basis of the at least one operating characteristic quantity and a cylinder pressure quantity that characterizes a cylinder pressure, a correction value for correcting the control quantity.
